(19) United States
(12) Patent Application Publication
(10) Pub. No.: US 2008/0106371 A1
(43) Pub. Date: May 8, 2008

(54) METHOD AND SYSTEM FOR VERIFYING AUTHENTICITY OF AN OBJECT

(75) Inventors: Yin-Hung Tseng, Chiayi City (TW); Sheng-Chun Hsu, Taitung Hsien (TW)

Correspondence Address: FOLEY AND LARDNER LLP;SUITE 500, 3000 K STREET NW, WASHINGTON, DC, 20007, US

(73) Assignee: USERSTAR INFORMATION SYSTEM CO., LTD.

(21) Appl. No.: 11/551,330

(22) Filed: Oct. 20, 2006

(51) Int. Cl. G05B 19/00

(52) U.S. Cl. 340/5.8; 340/5.26; 340/5.6

(57) ABSTRACT

A method for verifying authenticity of an object includes the steps of: enabling a code-generating device to generate and show a symbol based on at least two of a unique identification code of the code-generating device, and first and second authentication codes generated by the code-generating device based on a varying secret key; and enabling an electronic device to forward an image of the symbol to an authenticating device for verification. A system, which includes the code-generating device, the electronic device, and the authenticating device, and which performs the method is also disclosed.

### BACKGROUND OF THE INVENTION

1. Field of the Invention

The invention relates to a method and system for verifying authenticity of an object, more particularly to a method and system for verifying authenticity of an object with the use of a varying secret key.

2. Description of the Related Art

In U.S. Patent Application Publication No 20050087604, there is disclosed a conventional secure card provided with a uniquely identifiable coded authorization mark and a uniquely identifiable coded information mark that can be decoded to authenticate the secure card.

The aforementioned secure card is disadvantageous in that, since the authorization and information marks are fixed, the authorization and information marks can be easily reproduced on a counterfeit card The conventional secure card is, therefore, prone to fraud.

### SUMMARY OF THE INVENTION

Therefore, the object of the present invention is to provide a method and system for verifying authenticity of an object that can overcome the aforesaid drawback of the prior art.

According to one aspect of the present invention, a method for verifying authenticity of an object is to be implemented using a system that includes a code-generating device associated with the object, an electronic device, and an authenticating device, and comprises the steps of: enabling the code-generating device to generate a varying secret key, a first authentication code based on the varying secret key, a second authentication code based on a unique identification code of the code-generating device and the varying secret key, and a symbol based on at least two of the unique identification code of the code-generating device and the first and second authentication codes, and to show the symbol; and enabling the electronic device to forward an image of the symbol to the authenticating device for verification.

According to another aspect of the inventions a system for verifying authenticity of an object comprises a code-generating device, an electronic device, and an authenticating device. The code-generating device is associated with the object, has a unique identification code, and includes a chip and a display. The chip is operable so as to generate a varying secret key, a first authentication code based on the varying secret key, a second authentication code based on the unique identification code of the code-generating device and the varying secret key, and a symbol based on at least two of the unique identification code of the code-generating device and the first and second authentication codes. The display is coupled to the chip, and is operable so as to show the symbol generated by the chip. The electronic device is operable to forward an image of the symbol shown by the display to the authenticating device for verification.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of the preferred embodiment of a system for verifying authenticity of an object according to the present invention; and

FIGS. 2A to 2D are flowcharts of the preferred embodiment of a method for verifying authenticity of an object according to the present invention

### DETAILED DESCRIPTION OF THE PREFERRED EMBODIMENTS

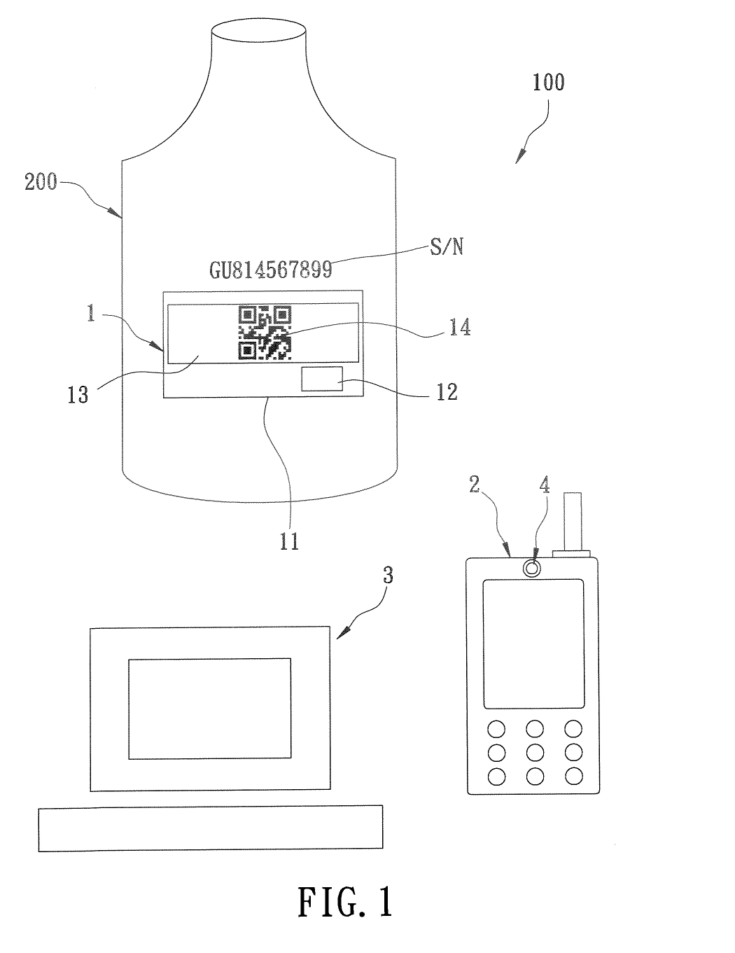

Referring to FIG. 1, the preferred embodiment of a system 100 according to this invention is shown to include a code-generating device 1, an electronic device 2, and an authenticating device 3.

The system 100 is applied for verifying authenticity of an object 200, in a manner that will be described in greater detail hereinafter.

The object 200 has a serial number (S/N), e.g., “GU814567899”. In this embodiment, the object 200 is a consumer product, such as a bottle of wine. In an alternative embodiment, the object 200 maybe an artwork, a security bond, or a certificate.

The code-generating device 1 is associated with the object 200, has a unique identification number, and includes a chip 11 and a display 13.

The chip 11 of the code-generating device 1 is operable so as to generate a varying secret key, a first authentication code based on the varying secret key, a second authentication code based on the unique identification code of the code-generating device 1 and the varying secret key, and a symbol 14 based on at least two of the unique identification code of the code-generating device 1 and the first and second authentication codes. In this embodiment, the chip 11 of the code-generating device 1 is configured with a chip code, e.g., “003027033001029” that serves as the unique identification number of the code-generating device 1.

It is noted that the unique identification number of the code-generating device 1 corresponds to the serial number (S/N) of the object 200.

The display 13 of the code-generating device 1 is coupled to the chip 11, and is operable so as to show the symbol 14 generated by the chip 11.

In this embodiment, the symbol 14 may be one of a one-dimensional symbol, a two-dimensional symbol, and a three-dimensional symbol.

The code-generating device 1 further includes an actuator 12 that is coupled to the chip 11, and that is operable so as to enable the chip 11 to generate the varying secret key and the first and second authentication codes. In this embodiment, the actuator 12 is a keypad. In an alternative embodiment, the actuator 12 may be one of a voice-activated actuator, a touch screen, a wireless actuator, and timer software application.

The electronic device 2 is operable to forward an image of the symbol 14 shown by the display 13 to the authenticating device 3 for verification. In this embodiment, the electronic device 2 is a mobile phone. In an alternative embodiment, the electronic device 2 may be one of a personal digital assistant (PDA) and a notebook computer.

It is noted that the electronic device 2 forwards the image of the symbol 14 to the authenticating device 3 via a network connection, such as an Internet connection.

The system 100 further includes an image-capturing device 4 that is built into the electronic device 2, that captures the image of the symbol 14, and that provides the image of the symbol 14 to the electronic device 2.

The authenticating device 3, which is software application installed in a server, is operable so as to determine the unique identification code of the code-generating device 1 and the first and second authentication codes from the image of the symbol 14 forwarded by the electronic device 2, so as to generate a verifying code that is based on two of the unique identification code of the code-generating device 1 and the first and second authentication codes determined by the authenticating device 3, so as to compare the verifying code with the remaining one of the unique identification code of the code-generating device 1 and the first and second authentication codes in order to verify authenticity of the object 200, and so as to forward a comparison result to the electronic device 2.

In this embodiment, the electronic device 2 is operable in a forward mode, where the electronic device 2 forwards the comparison result to a preset email account of the user automatically, an upload mode, where the electronic device 2 uploads the comparison result to an Internet website automatically, and a transmit mode, where the electronic device 2 sends the comparison result to a preset facsimile machine of the user automatically.

The chip 11 of the code-generating device 1 is further configured with first to seventh lookup tables as follows:

First Lookup Table

| Group 1 | 1 | 2 | 3 | 4 | 5 | 6 | 7 | 8 | 9 | 10 |
|---|---|---|---|---|---|---|---|---|---|---|
| Identifier Code 1 | A | B | C | D | E | F | G | H | I | J |
| Identifier Code 2 | K | L | M | N | O | P | Q | R | S | T |
| Identifier Code 3 | U | V | W | X | Y | Z | 0 | 1 | 2 | 3 |

Second Lookup Table

| Group 2 | 000 | 001 | 002 | 003 | 004 | 005 | . . . | 027 | 028 | 029 | 030 | 031 | 032 | 033 |
|---|---|---|---|---|---|---|---|---|---|---|---|---|---|---|
| Identifier | AA | AB | AC | AD | AE | AF | . . . | A1 | A2 | A3 | A4 | A5 | A6 | BA |
| Code | | | | | | | | | | | | | | |

Third Lookup Table

| Group 3 | 01 | 02 | 03 | 04 | 05 | 06 | 07 | 08 | 09 | 10 | 11 | 12 |
|---|---|---|---|---|---|---|---|---|---|---|---|---|
| Identifier Code | A | B | C | D | E | F | G | H | I | J | K | L |
| 1 | | | | | | | | | | | | |
| Identifier Code | M | N | O | P | Q | R | S | T | U | V | W | X |
| 2 | | | | | | | | | | | | |
| Identifier Code | Y | Z | 1 | 2 | 3 | 4 | 5 | 6 | 7 | 8 | 9 | 0 |
| 3 | | | | | | | | | | | | |

Fourth Lookup Table

| Group 4 | 01 | 02 | 03 | 04 | 05 | 06 | 07 | 08 | 09 | 10 |
|---|---|---|---|---|---|---|---|---|---|---|
| Identifier Code | 1 | 2 | 3 | 4 | 5 | 6 | 7 | 8 | 9 | 10 |
| Group 4 | 11 | 12 | 13 | 14 | 15 | 16 | 17 | 18 | 19 | 20 |
| Identifier Code | A | B | C | D | E | F | G | H | I | J |

| Group 4 | 21 | 22 | 23 | 24 | 25 | 26 | 27 | 28 | 29 | 30 | 31 |
|---|---|---|---|---|---|---|---|---|---|---|---|
| Identifier Code | K | L | M | N | O | P | Q | R | S | T | U |

Fifth Lookup Table

| Group 5 | 1 | 2 | 3 | 4 | 5 | 6 | 7 | 8 | 9 | 10 | 11 | 12 |
|---|---|---|---|---|---|---|---|---|---|---|---|---|
| Identifier Code | A | B | C | D | E | F | G | H | I | J | K | L |
| Group 5 | 13 | 14 | 15 | 16 | 17 | 18 | 19 | 20 | 21 | 22 | 23 | 24 |
| Identifier Code | M | N | O | P | Q | R | S | T | U | V | W | X |

Sixth Lookup Table

| Identifier code | Algorithm | Permutation |
|---|---|---|
| AAA | 132456 | BQAEUI3024 |
| AAB | 5123476 | IBAEQU2430 |
| AAC | 5671234 | I3024BAEQU |
| AAD | 2347615 | AEQU2430BI |

Seventh Lookup Table

| Identifier Code | Algorithm | Permutation |
|---|---|---|
| A | 1234 | ADA1BAABA3093024 |
| B | 1324 | ADA1A309BAAB3024 |
| C | 1243 | ADA1BAAB3024A309 |
| D | 1423 | ADA13024BAABA309 |

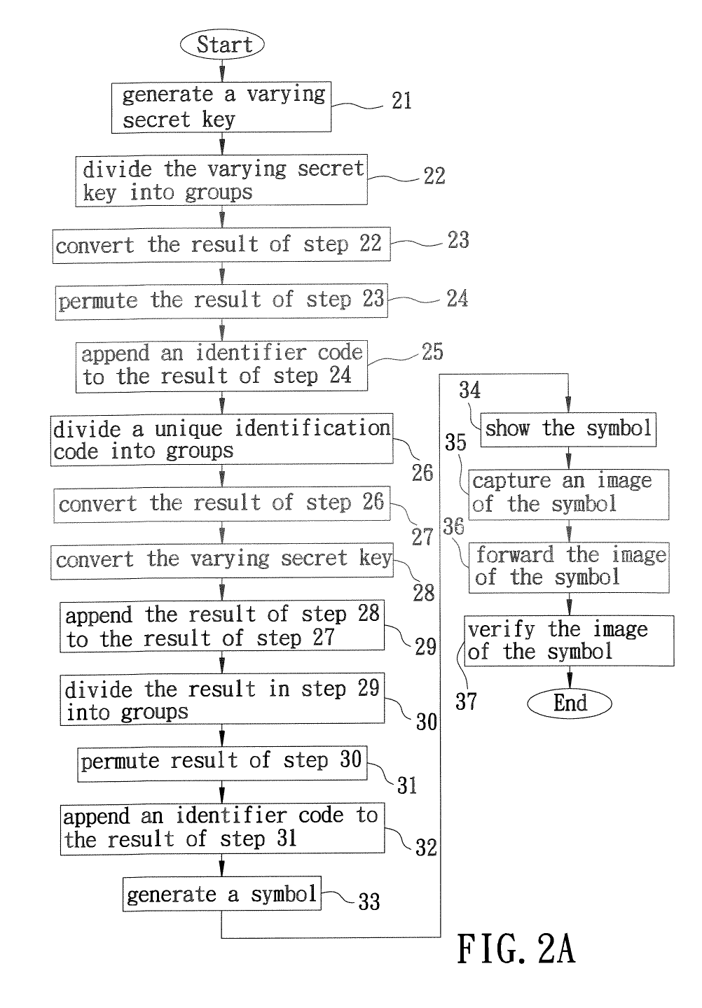

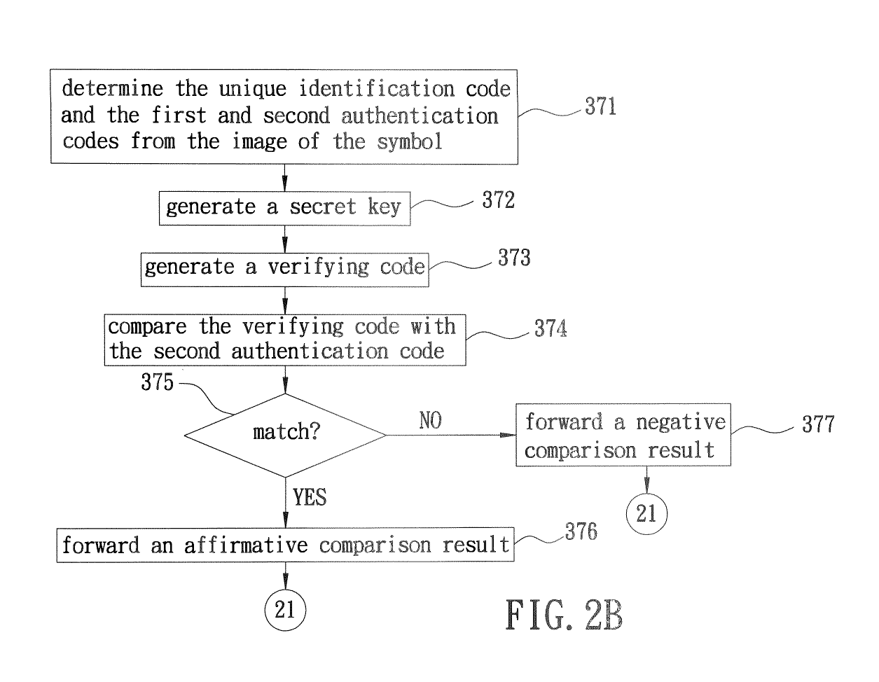

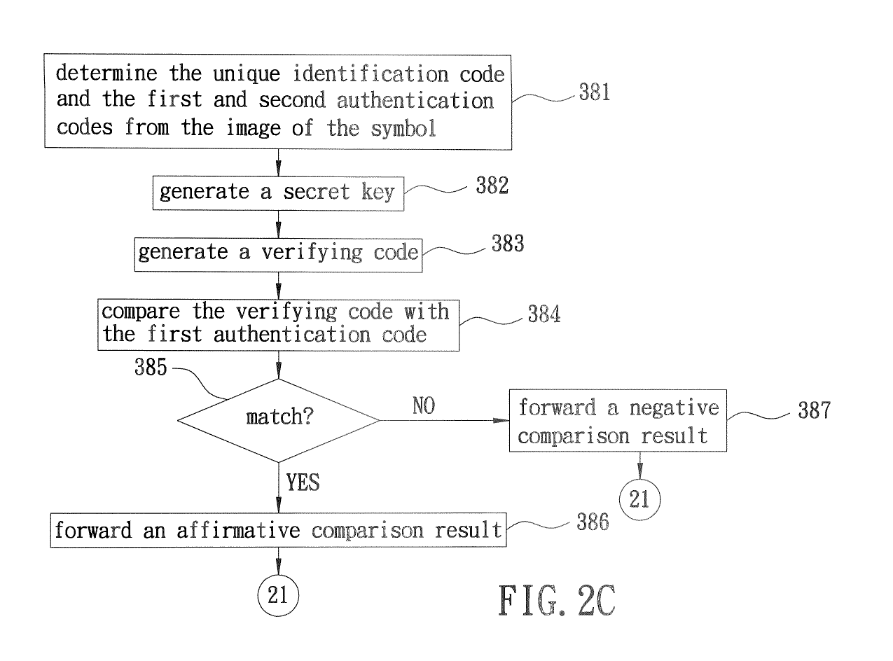

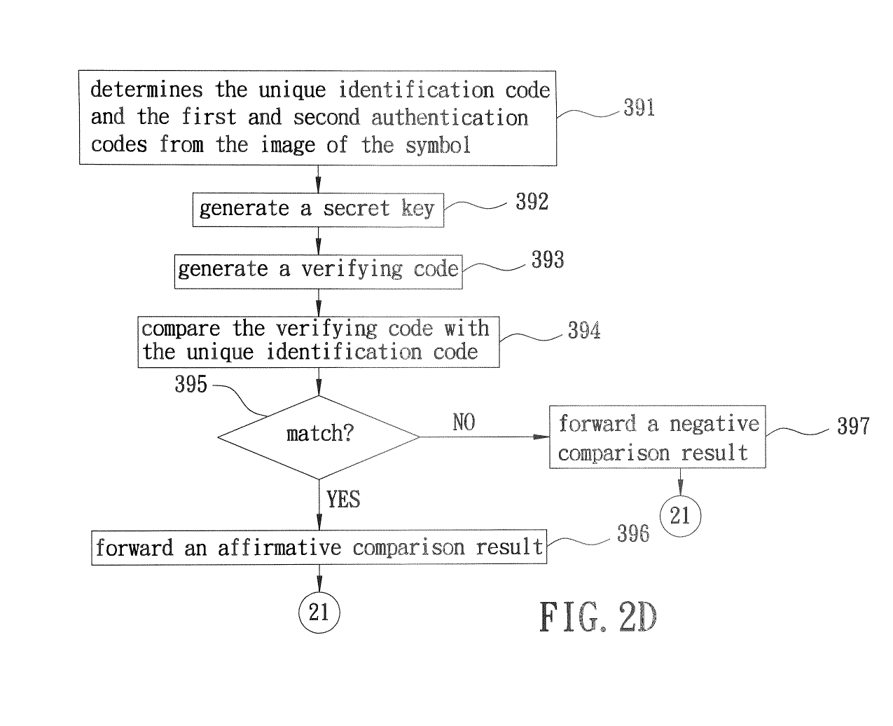

The preferred embodiment of a method for verifying authenticity of the object 200 to be implemented using the aforementioned system 100 according to this invention includes the steps shown in FIGS. 2A to 2D.

In step 21, upon operation of the actuator 12 of the code-generating device 1, the chip 11 of the code-generating device 1 generates the varying secret key. In this embodiment, the varying secret key is a function of date and time. For example, when the actuator 12 is operated on May 31, 2004 at 9:30:24 AM, the chip 11 generates a varying secret key as “20040531093024”.

In step 22, the chip 11 of the code-generating device 1 divides the varying secret key generated in step 21 into seven groups. For example, for the exemplified varying secret key of “20040531093024”, the first group corresponds to “2”, the second group corresponds to “004”, the third group corresponds to the “05”, the fourth group corresponds to “31”, the fifth group corresponds to “09”, the sixth group corresponds to “30”, and the seventh group corresponds to “24”.

In step 23, the chip 11 of the code-generating device 1 converts each of the first to fifth groups into a corresponding identifier code using a respective one of the first to fifth lookup tables configured therein, leaving the sixth and seventh groups unchanged. It is noted that since the first group (e.g., 2) has three corresponding identifier codes (e.g., B, L, and V), as illustrated in the first lookup table, and since the third group of the varying secret key (e.g. 05) has three corresponding identifier codes (e.g. E, Q, and 3), as illustrated in third lookup table, there are nine possible conversions for the varying secret key, “20040530093024”, one of which is “BAEQUI3024”.

Thereafter, in step 24, the chip 11 of the code-generating device 1 permutes the seven groups by selecting one of predetermined permutations stored in the sixth lookup table. With reference to the sixth lookup table, there are five thousand forty possible permutations for “BAEQUI3024”, one of which is “AEQU2430BI”.

In step 25, the chip 11 of the code-generating device 1 appends the identifier code, which corresponds to the selected one of the predetermined permutations, to the selected one of the predetermined permutations in order to obtain the first authentication code. With reference to the sixth lookup table, since the identifier code for “AEQU2430BI” is “AAD”, the first authentication code is “AEQU2430BIAAD”. In an alternative embodiment, steps 22 to 25 are skipped, and the first authentication code takes the value of the varying secret key generated in step 21.

In step 26, the chip 11 of the code-generating device 1 divides the unique identification code of the code-generating device 1 into five groups. For example, for the exemplified unique identification code of the code-generating device 1, “003027033001029”, the first group corresponds to “003”, the second group corresponds to “027”, the third group corresponds to “033”, the fourth group corresponds to “001”, and the fifth group corresponds to “029”.

In step 27, the chip 11 of the code-generating device 1 converts each of the first to fifth groups into a corresponding identifier code using the second lookup table configured therein to thereby obtain “ADA1BAABA3”.

In step 28, the chip 11 of the code-generating device 1 converts the varying secret key by discarding the first eight digits of the varying secret key to thereby obtain “093024”.

In step 29, the chip 11 of the code-generating device 1 appends “093024” obtained in step 28 to “ADA1BAABA3” obtained in step 27 to thereby obtain “ADA1BAABA3093024”.

In step 30, the chip 11 of the code-generating device 1 divides the result obtained in step 29 into four groups. The first group corresponds to “ADA1”, the second group corresponds to “BAAB”, the third group corresponds to “A309”, and the fourth group corresponds to “3024”.

In step 31, the chip 11 of the code-generating device 1 permutes the four groups by selecting one of predetermined permutations stored in the seventh lookup table. With reference to the seventh lookup table, there are twenty-four possible permutations for “ADA1BAABA3093024”, one of which is “ADA1A309BAAB3024”.

In step 32, the chip 11 of the code-generating device 1 appends the identifier code, which corresponds to the selected one of the predetermined permutations, to the selected one of the predetermined permutations in order to obtain the second authentication code. With reference to the seventh lookup table, since the identifier code for “ADA1A309BAAB3024” is “B”, the second authentication code is “ADA1A309BAAB3034B”.

In step 33, the chip 11 of the code-generating device 1 generates a two-dimensional symbol 14 based on the unique identification code of the code-generating device 1 and the first and second authentication codes. In step 34, the display 13 of the code-generating device 1 shows the two-dimensional symbol 14 generated in step 33.

In step 35, the image-capturing device 4 captures an image of the symbol 14 shown on the display 13 and provides the image of the symbol 14 to the electronic device 2.

In step 36, the electronic device 2 forwards the image of the symbol 14 to the authenticating device 3.

In step 37, the authenticating device 3 verifies the image of the symbol 14 forwarded by the electronic device 2.

In this embodiment, step 37 includes the sub-steps shown in FIG. 2B.

Sub-step 371: the authenticating device 3 determines the unique identification code of the code-generating device 1 and the first and second authentication codes from the image of the symbol 14 forwarded by the electronic device 2.

Sub-step 372: the authenticating device 3 generates a secret key based on the first authentication code determined in sub-step 371 by performing steps 22 to 25 in reverse.

Sub-step 373: the authenticating device 3 generates a verifying code based on the unique identification code of the code-generating device 1 determined in sub-step 371 and the secret key generated in sub-step 372 by performing steps 26 to 32.

Sub-step 374: the authenticating device 3 compares the verifying code generated in sub-step 373 with the second authentication code determined in sub-step 371.

Sub-step 375: when the verifying code matches the second authentication code in sub-step 374, the flow proceeds to sub-step 376. Otherwise, the flow proceeds to sub-step 377.

Sub-step 376: the authenticating device 3 forwards a comparison result to the electronic device 2, which indicates that the object 200 is genuine. Thereafter, the flow goes back to step 21.

Sub-step 377: the authenticating device 3 forwards a comparison result to the electronic device 2, which indicates that the object 200 is a counterfeit. Thereafter, the flow goes back to step 21.

In an alternative embodiment, step 37 includes the sub-steps shown in FIG. 2C.

Sub-step 381: the authenticating device 3 determines the unique identification code of the code-generating device 1 and the first and second authentication codes from the image of the symbol 14 forwarded by the electronic device 2.

Sub-step 382: the authenticating device 3 generates a secret key based on the unique identification code of the code-generating device 1 and the second authentication code determined in sub-step 381 by performing steps 26 to 32 in reverse.

Sub-step 383: the authenticating device 3 generates a verifying code based on the secret key obtained in sub-step 382 by performing steps 22 to 25.

Sub-step 384: the authenticating device 3 compares the verifying code obtained in sub-step 383 with the first authentication code determined in sub-step 381.

Sub-step 385: when the verifying code matches the first authentication code in sub-step 384, the flow proceeds to sub-step 386. Otherwise, the flow proceeds to sub-step 387.

Sub-step 386: the authenticating device 3 forwards a comparison result to the electronic device 2, which indicates that the object 200 is genuine. Thereafter, the flow goes back to step 21.

Sub-step 387: the authenticating device 3 forwards a comparison result to the electronic device 2, which indicates that the object 200 is a counterfeit. Thereafter, the flow goes back to step 21.

In yet another embodiment, step 37 includes the sub-steps shown in FIG. 2D.

Sub-step 391: the authenticating device 3 determines the unique identification code of the code-generating device 1 and the first and second authentication codes from the image of the symbol 14 forwarded by the electronic device 2.

Sub-step 392: the authenticating device 3 generates a secret key based on the first authentication code generated in sub-step 391 by performing steps 22 to 25 in reverse.

Sub-step 393: the authenticating device 3 generates a verifying code based on the second authentication code 5 determined in sub-step 391 and the secret key generated in sub-step 392 by performing steps 26 to 32 in reverse.

Sub-step 394: the authenticating device 3 compares the verifying code generated in sub-step 393 with the unique identification code of the code-generating device 1 determined in sub-step 391.

Sub-step 395: when the verifying code matches the unique identification code of the code-generating device 1 in sub-step 394, the flow proceeds to sub-step 396. Otherwise, the flow proceeds to sub-step 397.

Sub-step 396: the authenticating device 3 forwards a comparison result to the electronic device 2, which indicates that the object 200 is genuine. Thereafter, the flow goes back to step 21.

Sub-step 397: the authenticating device 3 forwards a comparison result to the electronic device 2, which indicates that the object 200 is a counterfeit. Thereafter, the flow goes back to step 21.

In an alternative embodiment, the authenticating device 3 is configured with a database that stores the unique identification code of the code-generating device 1 and the serial number (S/N) of the object 200. The symbol 14 is generated based on the first and second authentication codes. The authenticating device 3 determines the first and second authentication codes from an image of the symbol 14 forwarded by the electronic device 2, generates an identification code based on the first and second authentication codes determined thereby, and compares the identification code generated thereby with the unique identification code in the database thereof. When the identification code generated by the authenticating device 3 matches the unique identification code in the database of the authenticating device 3, the authenticating device 3 sends the serial number (S/N) to the electronic device 2 as a comparison result. When the serial number (S/N) forwarded by the authenticating device 3 matches the serial number (S/N) of the object 200, the object 200 is determined to be genuine. Otherwise, the object 200 is determined to be a counterfeit.

From the above description, since the varying secret key generated by the chip 11 of the code-generating device 1 is a function of date and time, the first and second authentication codes, as well as the symbol 14, generated by the chip 11 of the code-generating device 1 vary with the date and time each time the actuator 12 of the code-generating device 1 is operated. As such, the symbol 14 cannot be easily copied to a counterfeit object, a dedicated verification device is not required, and any person, including the consumer, can verify the authenticity of the object 200 through the authenticating device 3.

It is noted that the code-generating device 1 is attached securely on the object 200, and unauthorized removal of the code-generating device 1 from the object 200 can render the code-generating device 1 inoperative. As such, the code-generating device 1 is prevented from being used on other objects.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements

What is claimed is:

1. A method for verifying authenticity of an object to be implemented using a system that includes a code-generating device associated with the object, an electronic device, and an authenticating device, said method comprising the steps of:
(A) enabling the code-generating device
to generate a varying secret key, a first authentication code based on the varying secret key, a second authentication code based on a unique identification code of the code-generating device and the varying secret key, and a symbol based on at least two of the unique identification code of the code-generating device and the first and second authentication codes, and
to show the symbol; and
(B) enabling the electronic device to forward an image of the symbol to the authenticating device for verification.

2. The method as claimed in claim 1, further comprising the step of:
(C) enabling the authenticating device to determine the unique identification code of the code-generating device and the first and second authentication codes from the image of the symbol forwarded by the electronic device, to generate a verifying code that is based on two of the unique identification code of the code-generating device and the first and second authentication codes determined by the authentication device, and to compare the verifying code with the remaining one of the unique identification code of the code-generating device and the first and second authentication codes in order to verify authenticity of the object.

3. The method as claimed in claim 1, further comprising the step of enabling an image-capturing device to capture the image of the symbol prior to step (B).

4. The method as claimed in claim 1, wherein the electronic device is one of a mobile phone, a personal digital assistant, and a notebook computer.

5. The method as claimed in claim 3, wherein the image-capturing device is built into the electronic device.

6. The method as claimed in claim 1, wherein, in step (B), the electronic device forwards the image of the symbol to the authenticating device via a network connection.

7. The method as claimed in claim 2, wherein step (C) includes the sub-step of enabling the authenticating device to forward a comparison result to the electronic device.

8. The method as claimed in claim 7, further comprising the step of enabling the electronic device to inform the comparison result to a user.

9. The method as claimed in claim 8, wherein the electronic device is operable in at least one of a forward mode, where the electronic device forwards the comparison result to a preset email account of the user automatically, an upload mode, where the electronic device uploads the comparison result to an Internet website automatically, and a transmit mode, where the electronic device sends the comparison result to a preset facsimile machine of the user automatically.

10. The method as claimed in claim 1, wherein the code-generating device includes a chip with a chip code that serves as the unique identification code of the code-generating device.

11. The method as claimed in claim 1, wherein the code-generating device stores a serial number of the object, which serves as the unique identification code of the code-generating device.

12. The method as claimed in claim 1, wherein, in step (A), the symbol is one of a one-dimensional symbol, a two-dimensional symbol, and a three-dimensional symbol.

13. A system for verifying authenticity of an object, comprising:
a code-generating device associated with the object and having a unique identification code, said code-generating device including
a chip operable so as to generate a varying secret key, a first authentication code based on the varying secret key, a second authentication code based on the unique identification code of said code-generating device and the varying secret key, and a symbol based on at least two of the unique identification code of said code-generating device and the first and second authentication codes, and
a display coupled to said chip, and operable so as to show the symbol generated by said chip;
an electronic device; and
an authenticating device;
wherein said electronic device is operable to forward an image of the symbol shown by said display to said authenticating device for verification.

14. The system as claimed in claim 13, wherein said authenticating device is operable so as to determine the unique identification code of said code-generating device and the first and second authentication codes from the image of the symbol forwarded by said electronic device, so as to generate a verifying code that is based on two of the unique identification code of said code-generating device and the first and second authentication codes determined by said authenticating device, so as to compare the verifying code with the remaining one of the unique identification code of said code-generating device and the first and second authentication codes in order to verify authenticity of the object, and so as to forward a comparison result to said electronic device.

15. The system as claimed in claim 13, further comprising an image-capturing device that captures the image of the symbol, and that provides the image of the symbol to said electronic device.

16. The system as claimed in claim 13, wherein said electronic device is one of a mobile phone, a personal digital assistant, and a notebook computer.

17. The system as claimed in claim 15, wherein said image-capturing device is built into said electronic device.

18. The system as claimed in claim 13, wherein said electronic device forwards the image of the symbol to said authenticating device via a network connection.

19. The system as claimed in claim 13, wherein said code-generating device further includes an actuator that is coupled to said chip and that is operable so as to enable said chip to generate the varying secret key and the first and second authentication codes.

20. The system as claimed in claim 19, wherein said actuator is one of a voice-activated actuator, a touch screen, a keypad, and timer software application.

21. The system as claimed in claim 13, wherein said chip has a chip code that serves as the unique identification code of said code-generating device.

22. The system as claimed in claim 13, wherein the unique identification code of said code-generating device corresponds to a serial number of the object.

23. The system as claimed in claim 13, wherein said code-generating device stores a serial number of the object that serves as the unique identification code of said code-generating device.

24. The system as claimed in claim 13, wherein said symbol is one of a one-dimensional symbol, a two-dimensional symbol, and a three-dimensional symbol.
